(19) United States
(12) Patent Application Publication
(10) Pub. No.: US 2020/0308451 A1
(43) Pub. Date: Oct. 1, 2020

(54) ADDITIVES TO IMPROVE PARTICLE DISPERSION FOR CMP SLURRY

(71) Applicant: Cabot Microelectronics Corporation, Aurora (IL)

(72) Inventors: Yang-Yao LEE, Tainan City (TW); Hsin-Yen WU, Kaohsiung City (TW); Cheng-Yuan KO, Kaohsiung City (TW); Lung-Tai LU, Tainan City (TW); Hung-Tsung HUANG, Tainan City (TW)

(21) Appl. No.: 16/826,409

(22) Filed: Mar. 23, 2020

Related U.S. Application Data
(60) Provisional application No. 62/823,258, filed on Mar. 25, 2019.

(51) Int. Cl. C09G 1/02; B24B 1/04

(52) U.S. Cl. CPC C09G 1/02; B24B 1/04

(57) ABSTRACT

The invention provides a chemical-mechanical polishing composition comprising (a) about 0.05 wt. % to about 10 wt. % of an abrasive; (b) a dispersant, wherein the dispersant is a linear or branched C₂-C₁₀ alkylenediol; and (c) water, wherein the chemical-mechanical polishing composition has a pH of about 2 to about 6. The invention also provides a method of chemically-mechanically polishing a substrate by contacting the substrate with the inventive chemical-mechanical polishing composition.

### BACKGROUND OF THE INVENTION

Compositions and methods for planarizing or polishing the surface of a substrate are well known in the art. Polishing compositions (also known as polishing slurries) typically contain an abrasive material in a liquid carrier and are applied to a surface by contacting the surface with a polishing pad saturated with the polishing composition. Typical abrasive materials include silicon dioxide, cerium oxide, aluminum oxide, zirconium oxide, and tin oxide. Polishing compositions are typically used in conjunction with polishing pads (e.g., a polishing cloth or disk). Instead of, or in addition to, being suspended in the polishing composition, the abrasive material may be incorporated into the polishing pad.

In many cases, it is desirable for the abrasive materials to have a narrow particle size distribution. When the abrasive is suspended in the polishing composition, the abrasive can aggregate or agglomerate on standing, thereby forming particles having significantly larger particle sizes than the average particle size of the abrasive materials. The increased proportion of abrasive particles having large particle sizes is thought to contribute to an increase in microscratches on the surfaces of substrates that are polished with polishing compositions comprising the same. Microscratches can contribute to substrate defectivities which fail to meet stringent quality requirements.

Thus, there remains in the art a need for polishing compositions having enhanced abrasive particle size stability.

### BRIEF SUMMARY OF THE INVENTION

The invention provides a chemical-mechanical polishing composition comprising (a) about 0.05 wt. % to about 10 wt. % of an abrasive; (b) a dispersant, wherein the dispersant is a linear or branched C₂-C₁₀ alkylenediol; and (c) water, wherein the chemical-mechanical polishing composition has a pH of about 2 to about 6.

The invention also provides a method of chemically-mechanically polishing a substrate comprising (i) providing a substrate; (ii) providing a polishing pad; (iii) providing a chemical-mechanical polishing composition comprising: (a) about 0.05 wt. % to about 10 wt. % of an abrasive; (b) a dispersant, wherein the dispersant is a linear or branched C₂-C₁₀ alkylenediol; and (c) water, wherein the chemical-mechanical polishing composition has a pH of about 2 to about 6; (iv) contacting the substrate with the polishing pad and the chemical-mechanical polishing composition; and (v) moving the polishing pad and the chemical-mechanical polishing composition relative to the substrate to abrade at least a portion of a surface of the substrate to polish the substrate.

### BRIEF DESCRIPTION OF THE SEVERAL VIEWS OF THE DRAWING(S)

FIG. 1 shows average particle size at 0, 1, 2, and 3 weeks of storage at 45° C. for polishing compositions comprising colloidal silica and 0 wt. %, 2 wt. %, or 10 wt. % of 1,4-butanediol at pH values of 3, 4, or 5.

FIG. 2 shows average particle size at 0, 1, 2, 3, 4, and 5 weeks of storage at 45° C. for polishing compositions comprising alumina surface-treated with a sulfonic acid-containing polymer and 0 wt. %, 0.5 wt. %, 2 wt. %, or 10 wt. % of 1,4-butanediol at pH values of 2 or 4.

### DETAILED DESCRIPTION OF THE INVENTION

The invention provides a chemical-mechanical polishing composition comprising, consisting essentially of, or consisting of (a) about 0.05 wt. % to about 10 wt. % of an abrasive; (b) a dispersant, wherein the dispersant is a linear or branched C₂-C₁₀ alkylenediol; and (c) water, wherein the chemical-mechanical polishing composition has a pH of about 2 to about 6.

The abrasive can be any suitable abrasive. The abrasive particles can comprise, consist essentially of, or consist of any suitable particulate material, which material typically is a metal oxide and/or a metalloid oxide (hereinafter collectively referred to as “metal oxides”). Examples of suitable materials include alumina, treated alumina (e.g., surface-treated alumina), colloidal silica, fumed silica, surface-modified silica, and combinations thereof.

The alumina can be any suitable alumina and can be, for example, α-alumina, γ-alumina, or fumed alumina. The alumina can be treated alumina, wherein the alumina particles can be surface-treated with anionic polymers such as polysulfonic acids, polystyrenesulfonic acids, copolymers comprising sulfonic acid monomeric units such as poly(2-acrylamido-2-methyl-1-propanesulfonic acid), and the like.

The silica can be an unmodified silica or a surface-modified silica, many of which are known in the art. For example, the surface-modified silica can be surface modified by doping with aluminum ions, by treatment with surface-modifying agents such as silanes, including amino-containing silanes, alkyl silanes, and the like. In a preferred embodiment, the silica can be colloidal silica (e.g., an unmodified colloidal silica).

When the silica is a colloidal silica, the colloidal silica can be any suitable colloidal silica. For example, the colloidal silica can be a wet process silica, such as a condensation-polymerized silica. Condensation-polymerized silica typically is prepared by condensing Si(OH)₄ to form colloidal particles, where colloidal is defined as having an average particle size between about 1 nm and about 1000 nm. Such abrasive particles can be prepared in accordance with U.S. Pat. No. 5,230,833 or can be obtained as any of various commercially available products, such as the Akzo-Nobel Bindzil™ 50/80, 30/360, 159/500, 40/220, 40/130, and CJ2-2 products and the Nalco 1050, 1060, 2327, and 2329 products, as well as other similar products available from DuPont, Bayer, Applied Research, Nissan Chemical, Fuso, and Clariant.

The polishing composition can comprise any suitable amount of abrasive. Typically, the polishing composition comprises about 1 wt. % or more of abrasive, e.g., about 1.5 wt. % or more, about 2 wt. % or more, or about 2.5 wt. % or more. Alternatively, or in addition, the polishing composition comprises about 5 wt. % or less of abrasive, e.g., about 4.5 wt. % or less, about 4 wt. % or less, or about 3.5 wt. % or less. Thus, the polishing composition can comprise abrasive in an amount bounded by any two of the aforementioned endpoints. For example, the polishing composition can comprise about 1 wt. % to about 5 wt. % of abrasive, e.g., about 1 wt. % to about 4.5 wt. %, about 1 wt. % to about 4 wt. %, about 1 wt. % to about 3.5 wt. %, about 1.5 wt. % to about 5 wt. %, about 1.5 wt. % to about 4.5 wt. %, about 1.5 wt. % to about 4 wt. %, about 1.5 wt. % to about 3.5 wt. %, about 2 wt. % to about 5 wt. %, about 2 wt. % to about 4.5 wt. %, about 2 wt. % to about 4 wt. %, about 2 wt. % to about 3.5 wt. %, about 2.5 wt. % to about 5 wt. %, about 2.5 wt. % to about 4.5 wt. %, about 2.5 wt. % to about 4 wt. %, or about 2.5 wt. % to about 3.5 wt. %.

The abrasive preferably is colloidally stable. The term colloid refers to the suspension of abrasive particles in the liquid carrier. Colloidal stability refers to the maintenance of that suspension through time. In the context of the invention, an abrasive is considered colloidally stable if, when the abrasive is placed into a 100 ml graduated cylinder and allowed to stand unagitated for a time of 2 hours, the difference between the concentration of particles in the bottom 50 ml of the graduated cylinder ([B] in terms of g/ml) and the concentration of particles in the top 50 ml of the graduated cylinder ([T] in terms of g/ml) divided by the initial concentration of particles in the abrasive composition ([C] in terms of g/ml) is less than or equal to 0.5 (i.e., {[B]−[T]}/[C]<0.5). More preferably, the value of [B]-[T]/[C] is less than or equal to 0.3, and most preferably is less than or equal to 0.1.

The abrasive can have any suitable average particle size (i.e., average particle diameter). The particle size of an abrasive particle is the diameter of the smallest sphere that encompasses the abrasive particle. The abrasive can have an average particle size of about 5 nm or more, e.g., about 10 nm or more, about 15 nm or more, about 20 nm or more, about 25 nm or more, about 30 nm or more, about 35 nm or more, about 40 nm or more, about 45 nm or more, about 50 nm or more, about 55 nm or more, about 60 nm or more, about 65 nm or more, about 70 nm or more, about 75 nm or more, about 80 nm or more, about 85 nm or more, about 90 nm or more, about 95 nm or more, or about 100 nm or more. Alternatively, or in addition, the abrasive can have an average particle size of about 200 nm or less, e.g., about 190 nm or less, about 180 nm or less, about 170 nm or less, about 160 nm or less, about 150 nm or less, about 140 nm or less, about 130 nm or less, about 120 nm or less, about 110 nm or less, about 100 nm or less, about 95 nm or less, about 90 nm or less, about 85 nm or less, about 80 nm or less, about 75 nm or less, or about 70 nm or less. Thus, the abrasive can have an average particle size bounded by any two of the aforementioned endpoints. For example, the abrasive can have an average particle size of about 10 nm to about 200 nm, e.g., about 10 nm to about 190 nm, about 10 nm to about 180 nm, about 15 nm to about 170 nm, about 20 nm to about 160 nm, about 20 nm to about 150 nm, about 20 nm to about 140 nm, about 20 nm to about 130 nm, about 20 nm to about 120 nm, about 20 nm to about 110 nm, about 100 nm to about 200 nm, about 100 nm to about 190 nm, about 100 nm to about 180 nm, about 100 nm to about 170 nm, about 100 nm to about 160 nm, about 100 nm to about 150 nm, about 10 nm to about 100 nm, about 25 nm to about 80 nm, or about 30 nm to about 70 nm.

The polishing composition comprises a dispersant, wherein the dispersant is a linear or branched C₂-C₁₀ alkylenediol. In certain embodiments, the dispersant is a linear or branched C₂-C₇ alkylenediol. In certain preferred embodiments, the dispersant is a linear or branched C₄-C₇ alkylenediol. In certain embodiments, the C₂-C₁₀ alkylenediol is a linear C₂-C₁₀ alkylenediol (e.g., a linear C₂-C₇ alkylenediol or a linear C₄-C₇ alkylenediol). As will be understood by those of skill in the art, an alkylenediol comprises an aliphatic carbon chain comprising two hydroxyl groups attached thereto, wherein the hydroxyl groups typically are attached to different carbon atoms of the alkylenediol. As will be further understood by those of skill in the art, a C₂ alkylenediol cannot be branched, since there are only two carbon atoms in a C₂ alkylenediol, while C₃-C₁₀ alkylenediols can be linear or branched, wherein the branch comprises one or more carbon atoms attached to the backbone chain of the alkylenediol. The alkylene diol can contain 2, 3, 4, 5, 6, 7, 8, 9, or 10 carbon atoms. In an embodiment, the dispersant is selected from 1,3-butanediol, 1,4-butanediol, 1,5-pentanediol, 1,6-hexanediol, 1,7-heptanediol, and combinations thereof. In a preferred embodiment, the dispersant is 1,4-butanediol.

The polishing composition can contain any suitable amount of dispersant. For example, the polishing composition can contain about 0.5 wt. % or more of dispersant, e.g., about 0.6 wt. % or more, about 0.7 wt. % or more, about 0.8 wt. % or more, about 0.9 wt. % or more, about 1 wt. % or more, about 1.1 wt. % or more, about 1.2 wt. % or more, about 1.3 wt. % or more, about 1.4 wt. % or more, about 1.5 wt. % or more, about 1.6 wt. % or more, about 1.7 wt. % or more, about 1.8 wt. % or more, about 1.9 wt. % or more, about 2 wt. % or more, about 2.1 wt. % or more, about 2.2 wt. % or more, about 2.3 wt. % or more, about 2.4 wt. % or more, about 2.5 wt. % or more, about 2.6 wt. % or more, about 2.7 wt. % or more, about 2.8 wt. % or more, about 2.9 wt. % or more, or about 3 wt. % or more. Alternatively, or in addition, the polishing composition can contain about 20 wt. % or less of dispersant, e.g., about 19.5 wt. % or less, about 19 wt. % or less, about 18.5 wt. % or less, about 18 wt. % or less, about 17.5 wt. % or less, about 17 wt. % or less, about 16.5 wt. % or less, about 16 wt. % or less, about 15.5 wt. % or less, about 15 wt. % or less, about 14.5 wt. % or less, about 14 wt. % or less, about 13.5 wt. % or less, about 13 wt. % or less, about 12.5 wt. % or less, about 12 wt. % or less, about 11.5 wt. % or less, about 11 wt. % or less, about 10.5 wt. % or less, or about 10 wt. % or less of dispersant. Thus, the polishing composition can comprise a dispersant in an amount bounded by any two of the aforementioned endpoints. For example, the polishing composition can comprise about 0.5 wt. % to about 20 wt. % of dispersant, e.g., about 0.5 wt. % to about 19 wt. %, about 0.5 wt. % to about 18 wt. %, about 0.5 wt. % to about 17 wt. %, about 0.5 wt. % to about 16 wt. %, about 0.5 wt. % to about 15 wt. %, about 0.5 wt. % to about 14 wt. %, about 0.5 wt. % to about 13 wt. %, about 0.5 wt. % to about 12 wt. %, about 0.5 wt. % to about 11 wt. %, about 0.5 wt. % to about 10 wt. %, about 1 wt. % to about 15 wt. %, about 1 wt. % to about 14 wt. %, about 1 wt. % to about 13 wt. %, about 1 wt. % to about 12 wt. %, about 1 wt. % to about 11 wt. %, about 1 wt. % to about 10 wt. %, about 2 wt. % to about 15 wt. %, about 2 wt. % to about 14 wt. %, about 2 wt. % to about 13 wt. %, about 2 wt. % to about 12 wt. %, about 2 wt. % to about 11 wt. %, about 2 wt. % to about 10 wt. %, about 3 wt. % to about 15 wt. %, about 3 wt. % to about 14 wt. %, about 3 wt. % to about 13 wt. %, about 3 wt. % to about 12 wt. %, about 3 wt. % to about 11 wt. %, or about 3 wt. % to about 10 wt. %.

The polishing composition comprises water. The water can be any suitable water and can be, for example, deionized water or distilled water. In some embodiments, the polishing composition can further comprise one or more organic solvents in combination with the water. For example, the polishing composition can further comprise a hydroxylic solvent such as methanol or ethanol, a ketonic solvent, an amide solvent, a sulfoxide solvent, and the like. Preferably, the polishing composition comprises pure water.

The polishing composition can have any suitable pH, for example a pH of about 1 to about 7. Typically, the polishing composition can have a pH of about 2 or more, e.g., about 2.2 or more, about 2.4 or more, about 2.6 or more, about 2.8 or more, or about 3 or more. Alternatively, or in addition, the polishing composition can have a pH of about 6 or less, e.g., about 5 or less, about 4.5 or less, about 4 or less, about 3.5 or less, or about 3 or less. Thus, the polishing composition can have a pH bounded by any two of the aforementioned endpoints. For example, the polishing composition can have a pH of about 2 to about 6, e.g., about 2 to about 5, about 2 to about 4, about 2.5 to about 5, about 2.5 to about 4.5, about 2.5 to about 4, or about 2 to about 4.5.

The polishing composition optionally comprises a mineral acid. Non-limiting examples of suitable mineral acids include nitric acid, sulfuric acid, and phosphoric acid.

The polishing composition can further comprise a base to adjust the pH of the polishing composition. Non-limiting examples of suitable bases include sodium hydroxide, potassium hydroxide, and ammonium hydroxide.

The polishing composition optionally further comprises an oxidizing agent. The oxidizing agent can be any suitable oxidizing agent. In certain embodiments, the oxidizing agent comprises ferric ion. The ferric ion can be provided by any suitable source of ferric ion. In some embodiments, the oxidizing agent can comprise a salt of the metal. For example, ferric ion can be provided by a ferric salt comprising inorganic anions such as nitrate ions (e.g., ferric nitrate), cyanide ions (e.g., ferricyanide anion), and the like. The oxidizing agent can also comprise ferric organic iron (III) compounds such as but not limited to acetates, acetylacetonates, citrates, gluconates, oxalates, phthalates, and succinates, and mixtures thereof. In other embodiments, the oxidizing agent can be an oxy-containing oxidizing agent. Non-limiting examples of suitable oxy-containing oxidizing agents include hydrogen peroxide, persulfate salts, bromate persulfate salts, iodate persulfate salts, perbromate persulfate salts, periodate persulfate salts, organic peroxy compounds such as peracetic acid, oxone, and the like.

The polishing composition can comprise any suitable amount of the oxidizing agent. For example, the polishing composition can comprise about 1 ppm or more of the oxidizing agent, for example, about 5 ppm or more, about 25 ppm or more, about 50 ppm or more, about 75 ppm or more, or about 100 ppm or more. Alternatively, or in addition, the polishing composition can comprise about 2500 ppm (about 2.5 wt. %) or less of the oxidizing agent, for example, about 2000 ppm or less, about 1500 ppm or less, about 1000 ppm or less, about 500 ppm or less, or about 250 ppm or less. Unless otherwise noted, the term ppm is meant to reflect a parts-per-million based upon weight. For example, 1000 ppm would be equivalent to 1 wt. %.

When the optional oxidizing agent comprises hydrogen peroxide, the hydrogen peroxide can be present in any suitable amount in the polishing composition. For example, the polishing composition can comprise about 0.1 wt. % to about 10 wt. % of hydrogen peroxide, e.g., about 0.5 wt. % to about 10 wt. %, or about 0.5 wt. % to about 5 wt. %.

The polishing composition optionally further comprises an amino acid. The amino acid can be any suitable amino acid. Non-limiting examples of suitable amino acids include glycine, alanine, lysine, and arginine. The polishing composition can contain any suitable amount of amino acid. For example, the polishing composition can comprise about 0.1 wt. % to about 5 wt. % of amino acid (about 100 ppm to about 5000 ppm), e.g., about 0.1 wt. % to about 4 wt. %, about 0.1 wt. % to about 3 wt. %, about 0.1 wt. % to about 2 wt. %, or about 0.1 wt. % to about 1 wt. %.

When the polishing composition comprises ferric ion (i.e., Fe(III) ion), the polishing composition optionally further comprises a stabilizer for ferric ion. The stabilizer for ferric ion can be any suitable stabilizer for ferric ion. A non-limiting example of a stabilizer for ferric ion is malonic acid. The polishing composition can contain any suitable amount of the stabilizer for ferric ion. For example, the polishing composition can comprise about 0.1 wt. % to about 2 wt. % of the stabilizer for ferric ion, e.g., about 0.1 wt. % to about 1.8 wt. %, about 0.1 wt. % to about 1.6 wt. %, about 0.1 wt. % to about 1.4 wt. %, about 0.1 wt. % to about 1.2 wt. %, or about 0.1 wt. % to about 1 wt. %.

The polishing composition can be prepared by any suitable technique, many of which are known to those skilled in the art. The polishing composition can be prepared in a batch or continuous process. Generally, the polishing composition can be prepared by combining the components thereof in any order. The term “component” as used herein includes individual ingredients (e.g., abrasive, dispersant, optional oxidizing agent, optional amino acid, etc.) as well as any combination of ingredients (e.g., abrasive, dispersant, optional oxidizing agent, optional amino acid, etc.).

For example, the abrasive can be dispersed in water. The dispersant can then be added, and mixed by any method that is capable of incorporating the components into the polishing composition. The optional oxidizing agent and optional amino acid can be added at any time during the preparation of the polishing composition. The polishing composition can be prepared prior to use, with one or more components, such as the oxidizing agent, for example, hydrogen peroxide, added to the polishing composition just before use (e.g., within about 1 minute before use, or within about 1 hour before use, or within about 7 days before use). The polishing composition also can be prepared by mixing the components at the surface of the substrate during the polishing operation.

The polishing composition can be supplied as a one-package system comprising abrasive, dispersant, optional oxidizing agent, optional amino acid, and water. Alternatively, the abrasive can be supplied as a dispersion in water in a first container, dispersant, optional oxidizing agent, and optional amino acid can be supplied in a second container, either in dry form, or as a solution or dispersion in water. When the oxidizing agent comprises hydrogen peroxide, the hydrogen peroxide desirably is supplied separately from the other components of the polishing composition and is combined, e.g., by the end-user, with the other components of the polishing composition shortly before use (e.g., 1 week or less prior to use, 1 day or less prior to use, 1 hour or less prior to use, 10 minutes or less prior to use, or 1 minute or less prior to use). The components in the first or second container can be in dry form while the components in the other container can be in the form of an aqueous dispersion. Moreover, it is suitable for the components in the first and second containers to have different pH values, or alternatively to have substantially similar, or even equal, pH values. Other two-container, or three or more-container, combinations of the components of the polishing composition are within the knowledge of one of ordinary skill in the art.

The polishing composition of the invention also can be provided as a concentrate which is intended to be diluted with an appropriate amount of water prior to use. In such an embodiment, the polishing composition concentrate can comprise the abrasive, dispersant, optional oxidizing agent, optional amino acid, and water, with or without the optional hydrogen peroxide, in amounts such that, upon dilution of the concentrate with an appropriate amount of water, and upon addition of the optional hydrogen peroxide if not already present in an appropriate amount, each component of the polishing composition will be present in the polishing composition in an amount within the appropriate range recited above for each component. For example, the abrasive, dispersant, optional oxidizing agent, optional amino acid, can each be present in the concentration in an amount that is about 2 times (e.g., about 3 times, about 4 times, or about 5 times) greater than the concentration recited above for each component so that, when the concentrate is diluted with an equal volume of (e.g., 2 equal volumes of water, 3 equal volumes of water, or 4 equal volumes of water, respectively), along with the optional hydrogen peroxide in a suitable amount, such that each component will be present in the polishing composition in an amount within the ranges set forth above for each component. Furthermore, as will be understood by those of ordinary skill in the art, the concentrate can contain an appropriate fraction of the water present in the final polishing composition in order to ensure that other components are at least partially or fully dissolved in the concentrate.

The invention also provides a method of chemically mechanically polishing a substrate comprising (i) providing a substrate, (ii) providing a polishing pad, (iii) providing a chemical-mechanical polishing composition as described herein, (iv) contacting the substrate with the polishing pad and the chemical-mechanical polishing composition, and (v) moving the polishing pad and the chemical mechanical polishing composition relative to the substrate to abrade at least a portion of a surface of the substrate to thereby polish the substrate.

More specifically, the invention also provides a provides a method of chemically mechanically polishing a substrate comprising (i) providing a substrate; (ii) providing a polishing pad, (iii) providing a chemical-mechanical polishing composition comprising: (a) about 0.05 wt. % to about 10 wt. % of an abrasive; (b) a dispersant, wherein the dispersant is a linear or branched C₂-C₁₀ alkylenediol; and (c) water, wherein the chemical-mechanical polishing composition has a pH of about 2 to about 6; (iv) contacting the substrate with the polishing pad and the chemical-mechanical polishing composition; and (v) moving the polishing pad and the chemical-mechanical polishing composition relative to the substrate to abrade at least a portion of a surface of the substrate to polish the substrate.

The substrate to be polished using the method of the invention can be any suitable substrate, especially a substrate that comprises at least one metal layer. The metal can be any suitable metal, for example, the metal can comprise, consist essentially of, or consist of a metal selected from tungsten, aluminum, nickel-phosphorous, copper, ruthenium, cobalt, and combinations thereof. In a preferred embodiment, the metal is tungsten. A preferred substrate comprises at least one layer on a surface of the substrate, especially an exposed layer for polishing, comprising, consisting essentially of, or consisting of a metal, such that at least a portion of the metal on a surface of the substrate is abraded (i.e., removed) to polish the substrate. In some embodiments, the substrate comprises at least one layer of metal and at least one layer of silicon oxide. In some preferred embodiments, the substrate comprises at least one layer of tungsten and at least one layer of silicon oxide. The inventive polishing composition and method are suitable for use in the so-called damascene polishing method for forming circuit lines on a suitable substrate, for example, silicon oxide, by etching of the silicon oxide surface to form circuit lines followed by overcoating of the substrate with a layer of tungsten to fill the circuit lines. The substrate comprising isolated tungsten circuit lines on a silicon oxide substrate is formed at least by chemical-mechanical polishing of the overcoat of tungsten to expose the silicon oxide substrate surface and thus produce isolated tungsten lines on the substrate. In some embodiments, the thus-formed substrate can be subjected to one or more subsequent polishing and/or cleaning steps to produce finished substrates.

Thus, in a preferred embodiment, the substrate comprises a tungsten layer on a surface of the substrate, wherein at least a portion of the tungsten layer is abraded to polish the substrate. In another preferred embodiment, the substrate comprises a silicon oxygen layer on a surface of the substrate, wherein at least a portion of the silicon oxide layer is abraded to polish the substrate. In another preferred embodiment, the substrate comprises a silicon nitrogen layer on a surface of the substrate, wherein at least a portion of the silicon nitride layer is abraded to polish the substrate. The substrate may comprise one or more of a tungsten layer on a surface of the substrate, a silicon oxygen layer on a surface of the substrate, and a silicon nitride layer on a surface of the substrate, wherein at least a portion of one or more of the tungsten layer, the silicon oxygen layer, and the silicon nitride layer is abraded to polish the substrate.

The inventive polishing composition desirably exhibits reduced growth in average particle size over time. The growth in average particle size is believed to be caused by aggregation of abrasive particles to increase the population of particles having relatively large particle sizes. The particles having relatively large particle sizes are believed to contribute to increased production of microscratches in substrates being polished, which microscratches may lead to increased substrate defectivity. The inventive polishing composition further desirably exhibits satisfactory removal rates when used to polish substrates, particularly substrates comprising tungsten and silicon oxide, while providing enhanced polishing performance with respect to substrate surface quality, in particular, in the reduced occurrence of microscratches in the substrates being polished.

The polishing method of the invention is particularly suited for use in conjunction with a chemical-mechanical polishing (CMP) apparatus. Typically, the apparatus comprises a platen, which, when in use, is in motion and has a velocity that results from orbital, linear, or circular motion, a polishing pad in contact with the platen and moving with the platen when in motion, and a carrier that holds a substrate to be polished by contacting and moving relative to the surface of the polishing pad. The polishing of the substrate takes place by the substrate being placed in contact with the polishing pad and the polishing composition of the invention and then the polishing pad moving relative to the substrate, so as to abrade at least a portion of the substrate to polish the substrate.

A substrate can be planarized or polished with the chemical-mechanical polishing composition with any suitable polishing pad (e.g., polishing surface). Suitable polishing pads include, for example, woven and non-woven polishing pads. Moreover, suitable polishing pads can comprise any suitable polymer of varying density, hardness, thickness, compressibility, ability to rebound upon compression, and compression modulus. Suitable polymers include, for example, polyvinylchloride, polyvinylfluoride, nylon, fluorocarbon, polycarbonate, polyester, polyacrylate, polyether, polyethylene, polyamide, polyurethane, polystyrene, polypropylene, coformed products thereof, and mixtures thereof.

Desirably, the CMP apparatus further comprises an in situ polishing endpoint detection system, many of which are known in the art. Techniques for inspecting and monitoring the polishing process by analyzing light or other radiation reflected from a surface of the workpiece are known in the art. Such methods are described, for example, in U.S. Pat. Nos. 5,196,353, 5,433,651, 5,609,511, 5,643,046, 5,658,183, 5,730,642, 5,838,447, 5,872,633, 5,893,796, 5,949,927, and 5,964,643. Desirably, the inspection or monitoring of the progress of the polishing process with respect to a workpiece being polished enables the determination of the polishing end-point, i.e., the determination of when to terminate the polishing process with respect to a particular workpiece.

Desirably, the inventive polishing composition exhibits decreased microscratching on substrates polished with the same. The inventive polishing composition also desirably exhibits enhanced storage stability.

The invention can be characterized by the following embodiments.

### EMBODIMENTS

(1) In embodiment (1) is presented a chemical-mechanical polishing composition comprising:
(a) about 0.05 wt. % to about 10 wt. % of an abrasive;
(b) a dispersant, wherein the dispersant is a linear or branched C₂-C₁₀ alkylenediol; and
(c) water,
wherein the chemical-mechanical polishing composition has a pH of about 1 to about 7.

(2) In embodiment (2) is presented the chemical-mechanical polishing composition of embodiment (1), wherein the composition comprises about 1 wt. % to about 5 wt. % of the abrasive.

(3) In embodiment (3) is presented the chemical-mechanical polishing composition of embodiment (1) or embodiment (2), wherein the composition comprises about 2.5 wt. % to about 3.5 wt. % of the abrasive.

(4) In embodiment (4) is presented the chemical-mechanical polishing composition of any one of embodiments (1)-(3), wherein the abrasive is selected from treated alumina, colloidal silica, fumed silica, surface-modified silica, and combinations thereof.

(5) In embodiment (5) is presented the chemical-mechanical polishing composition of any one of embodiments (1)-(4), wherein the abrasive is colloidal silica.

(6) In embodiment (6) is presented the chemical-mechanical polishing composition of embodiment (5), wherein the colloidal silica has a mean particle size of about 10 nm to about 100 nm.

(7) In embodiment (7) is presented the chemical-mechanical polishing composition of embodiment (6), wherein the colloidal silica has a mean particle size of about 30 nm to about 70 nm.

(8) In embodiment (8) is presented the chemical-mechanical polishing composition of any one of embodiments (1)-(7), wherein the composition comprises about 0.5 wt. % to about 20 wt. % of the dispersant.

(9) In embodiment (9) is presented the chemical-mechanical polishing composition of any one of embodiments (1)-(8), wherein the composition comprises about 1 wt. % to about 15 wt. % of the dispersant.

(10) In embodiment (10) is presented the chemical-mechanical polishing composition of any one of embodiments (1)-(9), wherein the composition comprises about 3 wt. % to about 10 wt. % of the dispersant.

(11) In embodiment (11) is presented the chemical-mechanical polishing composition of any one of embodiments (1)-(10), wherein the chemical-mechanical polishing composition has a pH of about 2 to about 5.

(12) In embodiment (12) is presented the chemical-mechanical polishing composition of any one of embodiments (1)-(11), wherein the chemical-mechanical polishing composition has a pH of about 2 to about 4.

(13) In embodiment (13) is presented the chemical-mechanical polishing composition of any one of embodiments (1)-(12), wherein the dispersant is a linear or branched C₂-C₇ alkylenediol.

(14) In embodiment (14) is presented the chemical-mechanical polishing composition of any one of embodiments (1)-(13), wherein the dispersant is a linear or branched C₄-C₇ alkylenediol.

(15) In embodiment (15) is presented the chemical-mechanical polishing composition of any one of embodiments (1)-(14), wherein the dispersant is 1,3-butanediol, 1,4-butanediol, 1,5-pentanediol, 1,6-hexanediol, 1,7-heptanediol, or a combination thereof.

(16) In embodiment (16) is presented the chemical-mechanical polishing composition of any one of embodiments (1)-(15), wherein the dispersant is 1,4-butanediol.

(17) In embodiment (17) is presented the chemical-mechanical polishing composition of embodiment (1), wherein the dispersant is a linear C₂-C₁₀ alkylenediol.

(18) In embodiment (18) is presented a method of chemically-mechanically polishing a substrate comprising:
(i) providing a substrate;
(ii) providing a polishing pad;
(iii) providing a chemical-mechanical polishing composition comprising:
   (a) about 0.05 wt. % to about 10 wt. % of an abrasive;
   (b) a dispersant, wherein the dispersant is a linear or branched C₂-C₁₀ alkylenediol; and
   (c) water,
   wherein the chemical-mechanical polishing composition has a pH of about 2 to about 6;
(iv) contacting the substrate with the polishing pad and the chemical-mechanical polishing composition; and
(v) moving the polishing pad and the chemical-mechanical polishing composition relative to the substrate to abrade at least a portion of a surface of the substrate to polish the substrate.

(19) In embodiment (19) is presented the method of embodiment (18), wherein the composition comprises about 1 wt. % to about 5 wt. % of the abrasive.

(20) In embodiment (20) is presented the method of embodiment (18) or embodiment (19), wherein the composition comprises about 2.5 wt. % to about 3.5 wt. % of the abrasive.

(21) In embodiment (21) is presented the method of any one of embodiments (18)-(20), wherein the abrasive is selected from treated alumina, colloidal silica, fumed silica, surface-modified silica, and combinations thereof.

(22) In embodiment (22) is presented the method of any one of embodiments (18)-(21), wherein the abrasive is colloidal silica.

(23) In embodiment (23) is presented the method of embodiment (22), wherein the colloidal silica has a mean particle size of about 10 nm to about 100 nm.

(24) In embodiment (24) is presented the method of embodiment (23), wherein the colloidal silica has a mean particle size of about 30 nm to about 70 nm.

(25) In embodiment (25) is presented the method of any one of embodiments (18)-(24), wherein the composition comprises about 0.5 wt. % to about 20 wt. % of the dispersant.

(26) In embodiment (26) is presented the method of any one of embodiments (18)-(25), wherein the composition comprises about 1 wt. % to about 15 wt. % of the dispersant.

(27) In embodiment (27) is presented the method of any one of embodiments (18)-(26), wherein the composition comprises about 3 wt. % to about 10 wt. % of the dispersant.

(28) In embodiment (28) is presented the method of any one of embodiments (18)-(27), wherein the chemical-mechanical polishing composition has a pH of about 2 to about 5.

(29) In embodiment (29) is presented the method of any one of embodiments (18)-(28), wherein the chemical-mechanical polishing composition has a pH of about 2 to about 4.

(30) In embodiment (30) is presented the method of any one of embodiments (18)-(29), wherein the dispersant is a linear or branched C₂-C₇ alkylenediol.

(31) In embodiment (31) is presented the method of any one of embodiments (18)-(30), wherein the dispersant is a linear or branched C₄-C₇ alkylenediol.

(32) In embodiment (32) is presented the method of any one of embodiments (18)-(31), wherein the dispersant is 1,3-butanediol, 1,4-butanediol, 1,5-pentanediol, 1,6-hexanediol, 1,7-heptanediol, or a combination thereof.

(33) In embodiment (33) is presented the method of any one of embodiments (18)-(32), wherein the dispersant is 1,4-butanediol.

(34) In embodiment (34) is presented the method of embodiment (18), wherein the dispersant is a linear C₂-C₁₀ alkylenediol.

(35) In embodiment (35) is presented the method of any one of embodiments (18)-(34), wherein the substrate comprises a tungsten layer on a surface of the substrate, and wherein at least a portion of the tungsten layer is abraded to polish the substrate.

(36) In embodiment (36) is presented the method of any one of embodiments (18)-(35), wherein the substrate further comprises a silicon oxygen layer on a surface of the substrate, and wherein at least a portion of the silicon oxygen layer is abraded to polish the substrate.

(37) In embodiment (37) is presented the method of any one of embodiments (18)-(36), wherein the substrate further comprises a silicon nitrogen layer on a surface of the substrate, and wherein at least a portion of the silicon nitrogen layer is abraded to polish the substrate.

The following examples further illustrate the invention but, of course, should not be construed as in any way limiting its scope.

### Example 1

This example demonstrates the stability of a polishing composition comprising colloidal silica and a dispersant, in accordance with an embodiment of the invention.

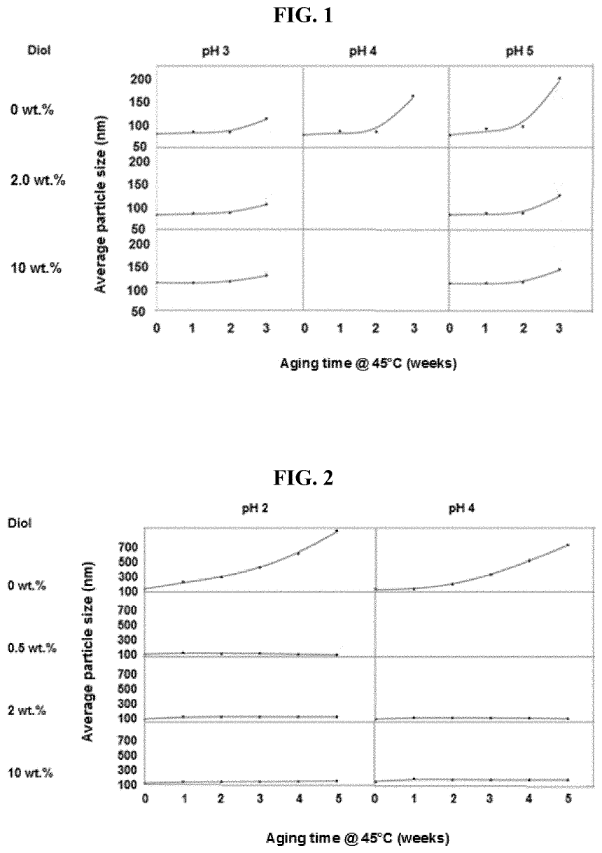

Polishing Compositions 1A-1G comprised 3 wt. % colloidal silica (Akzo Nobel CJ2-2), 1335 ppm malonic acid, 500 ppm glycine, 618 ppm of a 10% ferric nitrate solution, 2.5 wt. % hydrogen peroxide, Kathlon™, and varying amounts of 1,4-butanediol (i.e., a dispersant) at a pH of 3, 4, or 5, as set forth in Table 1. The average particle size was determined using a particle sizing instrument available from Malvern Panalytical (Malvern, UK) shortly after preparation of the polishing compositions and after storage of the polishing compositions at 45° C. for 1, 2, and 3 weeks. The results are shown graphically in FIG. 1.

TABLE 1
Amount of Dispersant and pH of Polishing Compositions 1A-1G

| | | | Initial Average |
|---|---|---|---|
| Polishing | Dispersant | | Particle Size |
| Composition | (wt. %) | pH | (nm) |
| 1A (comparative) | 0 | 3 | 80 |
| 1B (comparative) | 0 | 4 | 80 |
| 1C (comparative) | 0 | 5 | 80 |
| 1D (inventive) | 2 | 3 | 120 |
| 1E (inventive) | 2 | 5 | 120 |
| 1F (inventive) | 10 | 3 | 120 |
| 1G (inventive) | 10 | 5 | 120 |

As is apparent from the results shown in FIG. 1, the particles present in Polishing Compositions 1A-1C, which contained colloidal silica and did not contain a dispersant, and which had an initial average particle size of approximately 80 nm, exhibited average particle size increases to approximately 120 nm (Polishing Composition 1A), approximately 160 nm (Polishing Composition 1B) and approximately 200 nm (Polishing Composition 1C) after storage of the polishing compositions at 45° C. for 3 weeks). These particle size increases occurred at each of pH 3 (Polishing Composition 1A), pH 4 (Polishing Composition 1B), and pH 5 (Polishing Composition 1C).

Polishing Compositions 1F and 1G, which contained 10 wt. % of dispersant at pH values of 3 and 5, respectively, and which had an initial average particle size of approximately 120 nm, exhibited average particle size increases after storage at 45° C. for 3 weeks to approximately 130 nm (Polishing Composition 1F) and approximately 150 nm (Polishing Composition 1G). The smallest increase in average particle size (approximately 8%) after storage at 45° C. for 3 weeks was observed in Polishing Composition 1F, which contained colloidal silica and 10 wt. % of dispersant, at a pH of 3. As demonstrated by these results, the presence of dispersant significantly inhibits aggregation and thus prevents an increase in average particle size. For example, Polishing Composition 1A, having a pH of 3 and no dispersant, exhibited an increase in particle size of approximately 50%, while Polishing Composition 1F, having a pH of 3 and 10 wt. % of dispersant, exhibited an increase in particle size of approximately 8%.

### Example 2

This example demonstrates the stability of a polishing composition comprising alumina surface-treated with a sulfonic acid-containing polymer and a dispersant, in accordance with an embodiment of the invention.

Polishing Compositions 2A-2G comprised 250 ppm of alumina surface-treated with a sulfonic acid-containing polymer, 1080 ppm malonic acid, 1000 ppm lysine, 1000 ppm arginine, 500 ppm of ferric nitrate, 0.5 wt. % hydrogen peroxide, Kathlon™, and varying amounts of 1,4-butanediol (i.e., a dispersant) at a pH value of 2 or 4, as set forth in Table 2. The average particle size was determined using a particle sizing instrument available from Malvern Panalytical (Malvern, UK) shortly after preparation of the polishing compositions and after storage at 45° C. for 1, 2, and 3 weeks. The results are shown graphically in FIG. 2.

TABLE 2
Amount of Dispersant and pH of Polishing Compositions 2A-2G

| Polishing | Dispersant | |
|---|---|---|
| Composition | (wt. %) | pH |
| 2A (comparative) | 0 | 2 |
| 2B (comparative) | 0 | 4 |
| 2C (inventive) | 0.5 | 2 |
| 2D (inventive) | 2 | 2 |
| 2E (inventive) | 2 | 4 |
| 2F (inventive) | 10 | 2 |
| 2G (inventive) | 10 | 4 |

As is apparent from the results shown in FIG. 2, the particles present in Polishing Compositions 2A and 2B, which contained alumina surface-treated with a sulfonic acid-containing polymer and no dispersant, and which had an initial average particle size of approximately 150 nm, exhibited average particle size increases after storage at 45° C. for 3 weeks to approximately 950 nm (Polishing Composition 2A) and approximately 800 nm (Polishing Composition 2B). These particle size increases occurred at each of pH 2 (Polishing Composition 2A) and pH 4 (Polishing Composition 2B). The increases in average particle size for Polishing Compositions 2A and 2B were approximately 630% and 530%, respectively.

Polishing Compositions 2C-2G, which contained 0.5-10 wt. % of dispersant at a pH value of 2 or 4, exhibited substantially no particle size increase after storage at 45° C. for 3 weeks. As demonstrated by these results, the presence of dispersant in polishing compositions comprising alumina surface-treated with a sulfonic acid-containing polymer substantially completely inhibits aggregation and thus prevents an increase in average particle size.

### Example 3

This example demonstrates the removal rates for tungsten and silicon oxide provided by a polishing composition comprising an abrasive and a dispersant in accordance with an embodiment of the invention.

Polishing Compositions 3A-3E comprised 3 wt. % colloidal silica (mean particle size of 75 nm), 1500 ppm of a 10% wt. % ferric nitrate solution, 3240 ppm malonic acid, 2000 ppm lycine, 15 ppm Kathlon™, at a pH of 4.0. Polishing Composition 3A (comparative) did not contain a dispersant. Polishing Compositions 3B-3E (inventive) further contained 1 wt. %, 3 wt. %, 7 wt. %, and 9 wt. %, respectively, of 1,4-butanediol (i.e., a dispersant). Separate substrates comprising a blanket layer of tungsten or silicon oxide were polished with 5 polishing compositions (Polishing Compositions 3A-3E). Following polishing, the removal rates for tungsten and for silicon oxide were determined, and the results are set forth in Table 3.

TABLE 3
Tungsten (W) and Silicon Oxide (SiO) Removal
Rates as a Function of Dispersant

| Polishing | Dispersant | W Removal Rate | SiO Removal Rate |
|---|---|---|---|
| Composition | (wt. %) | (Å) | (Å) |
| 3A (comparative) | 0 | 184 | 394 |
| 3B (inventive) | 1 | 175 | 367 |
| 3C (inventive) | 3 | 182 | 343 |
| 3D (inventive) | 7 | 167 | 318 |
| 3E (inventive) | 9 | 162 | 310 |

As is apparent from the results set forth in Table 3, increasing the amount of 1,4-butanediol dispersant from 0 wt. % in Polishing Composition 3A to 9 wt. % in Polishing Composition 3E provided useful while somewhat reduced removal rates for tungsten and silicon oxide, while the presence of dispersant significantly inhibits particle size growth, as demonstrated herein in Example 1.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A chemical-mechanical polishing composition comprising:
(a) about 0.05 wt. % to about 10 wt. % of an abrasive;
(b) a dispersant, wherein the dispersant is a linear or branched C₂-C₁₀ alkylenediol; and
(c) water,
wherein the chemical-mechanical polishing composition has a pH of about 1 to about 7.

2. The chemical-mechanical polishing composition of claim 1, wherein the composition comprises about 2 wt. % to about 5 wt. % of the abrasive.

3. The chemical-mechanical polishing composition of claim 1, wherein the abrasive is selected from treated alumina, colloidal silica, fumed silica, surface-modified silica, and combinations thereof.

4. The chemical-mechanical polishing composition of claim 1, wherein the abrasive is colloidal silica.

5. The chemical-mechanical polishing composition of claim 4, wherein the colloidal silica has a mean particle size of about 10 nm to about 100 nm.

6. The chemical-mechanical polishing composition of claim 1, wherein the composition comprises about 0.5 wt. % to about 20 wt. % of the dispersant.

7. The chemical-mechanical polishing composition of claim 1, wherein the chemical-mechanical polishing composition has a pH of about 2 to about 5.

8. The chemical-mechanical polishing composition of claim 1, wherein the dispersant is a linear or branched C₂-C₇ alkylenediol.

9. The chemical-mechanical polishing composition of claim 1, wherein the dispersant is selected from 1,3-butanediol, 1,4-butanediol, 1,5-pentanediol, 1,6-hexanediol, 1,7-heptanediol, and combinations thereof.

10. The chemical-mechanical polishing composition of claim 1, wherein the dispersant is 1,4-butanediol.

11. The chemical-mechanical polishing composition of claim 1, wherein the dispersant is a linear C₂-C₁₀ alkylenediol.

12. A method of chemically-mechanically polishing a substrate comprising:
(i) providing a substrate;
(ii) providing a polishing pad;
(iii) providing a chemical-mechanical polishing composition comprising:
(a) about 0.05 wt. % to about 10 wt. % of an abrasive;
(b) a dispersant, wherein the dispersant is a linear or branched C₂-C₁₀ alkylenediol; and
(c) water,
wherein the chemical-mechanical polishing composition has a pH of about 2 to about 6;
(iv) contacting the substrate with the polishing pad and the chemical-mechanical polishing composition; and
(v) moving the polishing pad and the chemical-mechanical polishing composition relative to the substrate to abrade at least a portion of a surface of the substrate to polish the substrate.

13. The method of claim 12, wherein the composition comprises about 1 wt. % to about 5 wt. % of the abrasive.

14. The method of claim 12, wherein the abrasive is selected from treated alumina, colloidal silica, fumed silica, surface-modified silica, and combinations thereof.

15. The method of claim 12, wherein the abrasive is colloidal silica.

16. The method of claim 15, wherein the colloidal silica has a mean particle size of about 10 nm to about 100 nm.

17. The method of claim 12, wherein the composition comprises about 0.5 wt. % to about 20 wt. % of the dispersant.

18. The method of claim 12, wherein the chemical-mechanical polishing composition has a pH of about 2 to about 5.

19. The method of claim 12, wherein the dispersant is a linear or branched C₂-C₇ alkylenediol.

20. The method of claim 12, wherein the dispersant is selected from 1,3-butanediol, 1,4-butanediol, 1,5-pentanediol, 1,6-hexanediol, 1,7-heptanediol, and combinations thereof.

21. The method of claim 12, wherein the dispersant is 1,4-butanediol.

22. The method of claim 12, wherein the substrate comprises a tungsten layer on a surface of the substrate, and wherein at least a portion of the tungsten layer is abraded to polish the substrate.
